(19) United States
(12) Patent Application Publication
(10) Pub. No.: US 2008/0301236 A1
(43) Pub. Date: Dec. 4, 2008

(54) CONTEXTUAL SOCIAL LANGUAGE

(75) Inventors: Kamal Jain, Bellevue, WA (US); Christopher A. Meek, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/755,832

(22) Filed: May 31, 2007

(51) Int. Cl. G06F 15/16

(52) U.S. Cl. 709/206

(57) ABSTRACT

Systems and methods that enrich interaction of users in a written communication environment by providing a contextual language component that points to a designated data source (e.g., an object) and pulls data from such designated source, to perform predetermined function(s) thereupon. Users who communicate in the written environment can type an intuitive or customized operator, to engage in a predetermined functionality (e.g., playing a video). Accordingly, the operator can readily be interpreted by applications associated with the written communication environment.

### BACKGROUND

Emergence of global communication networks such as the Internet and major cellular networks has precipitated interaction between users in form of text messaging. Cellular and IP networks now function as a principal form of supporting written communications, and also as a central part of interactions among user applications that are based on text messaging. Network users now have mechanisms for searching and communicating/socializing on virtually any topic of interest via such text messaging systems.

Moreover, importance of text based electronic communications has increased. Common forms of text based and written communications between users over data networks include electronic mail and text chat sessions. For such systems, difficulties of communication caused by pronunciation or accent variations of different languages are mitigated. Furthermore, text messaging can be readily transmitted to remote locations in the world by employing a written environment. Accordingly, wireless telephones have continued to evolve, wherein in addition to providing subscriber voice communications, various types of text-based messaging (e.g., short messaging system) (SMS) messages, are now supported on many of such wireless cellular systems. Hence, users of compatible wireless systems are enabled to send character based messages to each other. Some cellular systems permit a subscriber to send an SMS message addressed to an Internet protocol (IP) address, wherein such messages can be received on a user's computer with an Internet connection.

Likewise, Instant Messaging (IM) has influenced activities for a large population of Internet users over the past few years for which such services have become available. Typically, instant messaging is extremely low-cost, with most vendors distributing the product freely or at nominal licensing fees. Such systems also support powerful applications, allowing users to exchange messages in one window without interrupting a task in progress in another window. Accordingly, team members in different locations can set up impromptu conversations, sharing ideas and strategies therebetween. IM systems further provide quick and easy collaboration, with little investments and not much set up. Users have the ability to conduct real-time conversations with other users, wherein friends and family keep in contact through group chat rooms and one-on-one chats, for example. An entire culture has been created based upon Instant Messaging. Nonetheless, such written communication environments typically lack the rich social interaction wherein users can readily exchange documents or visual material or gestures therebetween, for example.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation enriches interaction of users in a written communication environment (e.g., e-mails) by providing a contextual language component that points to a data source designated by a user (designated data source such as an object, for example), and further pulls data from such designated data source, to perform predetermined function(s) thereupon. The contextual language component employs an operator that can be defined by a user, and which can be readily understood by other users (e.g., employing intuitive constructs, such as dollar sign to indicate operators associated with finance applications). Such operators can describe what action(s) is to be performed on the designated data source and/or associated applications. In a related aspect, where to obtain such data, and how to display the data can also be defined by the operator. Hence, users who communicate in the written environment can type the operator, and engage in a predetermined functionality (e.g., playing a video). For example, a user can type an operator “video service; video” that can then be interpreted by the instant messenger application, wherein the first slide of the video is then presented to the users within the written communication environment (e.g., in an auxiliary window)—hence enriching the written communication between the users by playing the video.

The contextual language component can define a grammar and name of the operator(s), wherein such definition can employ intuitive terms/constructs that can be separated by commas. For example, the operators can employ intuitive keywords and common abbreviations for performance of predefined functions. The contextual language component can further interact with a search engine (which locates the designated data source), and a function definition component that describes the action that is to be performed on the designated data source.

In a related aspect, the search engine can employ personalized macros (e.g., defined by terms that are intuitive) created by a user, wherein such macros can be availed to another user in the written communication environment. For example, a user can write the macros in an Instant Messaging session (IM), and grant permission to another user to employ these macros. Similarly, in a web log (blog) environment, the permission can be granted to other users to access the search macro, and employ such personalized macro and communicate operators, which is created by the user.

According to a further aspect, the predetermined function(s) can relate to payment processing, wherein the operator can define amount and name of the payee. Such operator can employ intuitive terms that signify payment such as “pay amount”, wherein the designated sum can be transferred from the sender account to the recipient account, followed by a confirmation. The payment operator can also automatically initiate account verification process such as obtaining a secured password for the transfer process. For example, the payment operator can be employed when users have to settle debts, and can further be implemented in shopping applications.

In a related aspect, the predetermined function as defined by an operator can relate to sending a promotion/coupon and referral to another user. Such refer operator can typically supply accounting required for performance of the predetermined function (e.g., the name of the sender can be embedded in the promotion/coupon/recommendation/advertisement, which helps send the referral fee to the right account, even if the recipient buys the product later after closing the IM connection.) For example, a referral operator can be employed when a song is sent to the recipient, and if the recipient enjoys such song, then the recipient can purchase the song, wherein a referral fee can then be submitted to the sender.

The following description and the annexed drawings set forth in detail certain illustrative aspects of the claimed subject matter. These aspects are indicative, however, of but a few of the various ways in which the principles of such matter may be employed and the claimed subject matter is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of an exemplary communication system that employs a contextual language component in a written environment in accordance with an aspect of the subject innovation.

FIG. 2 illustrates a particular operator component as part of a written communication environment of the subject innovation.

FIG. 3 illustrates a further aspect of a contextual language component that employs a search engine according to an aspect of the subject innovation.

FIG. 4 illustrates a related methodology of enriching user experience during text messaging in accordance with an aspect of the subject innovation.

FIG. 5 illustrates a related methodology of enhancing the written communication between users in accordance with a further exemplary aspect of the subject innovation.

FIG. 6 illustrates an exemplary auxiliary window that can be employed within the written communication environment of the subject innovation.

FIG. 7 illustrates a particular contextual language component with an operator that defines predetermined functions related to payment processing according to an aspect of the subject innovation.

FIG. 8 illustrates an artificial intelligence (AI) component that can be employed to facilitate inferring and/or determining when, where, how to access the designated source as identified by the operator component in accordance with an aspect of the subject innovation.

FIG. 9 illustrates an exemplary operating environment for implementing various aspects of the subject innovation.

FIG. 10 illustrates a schematic block diagram of a sample computing environment with which the subject innovation can interact.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

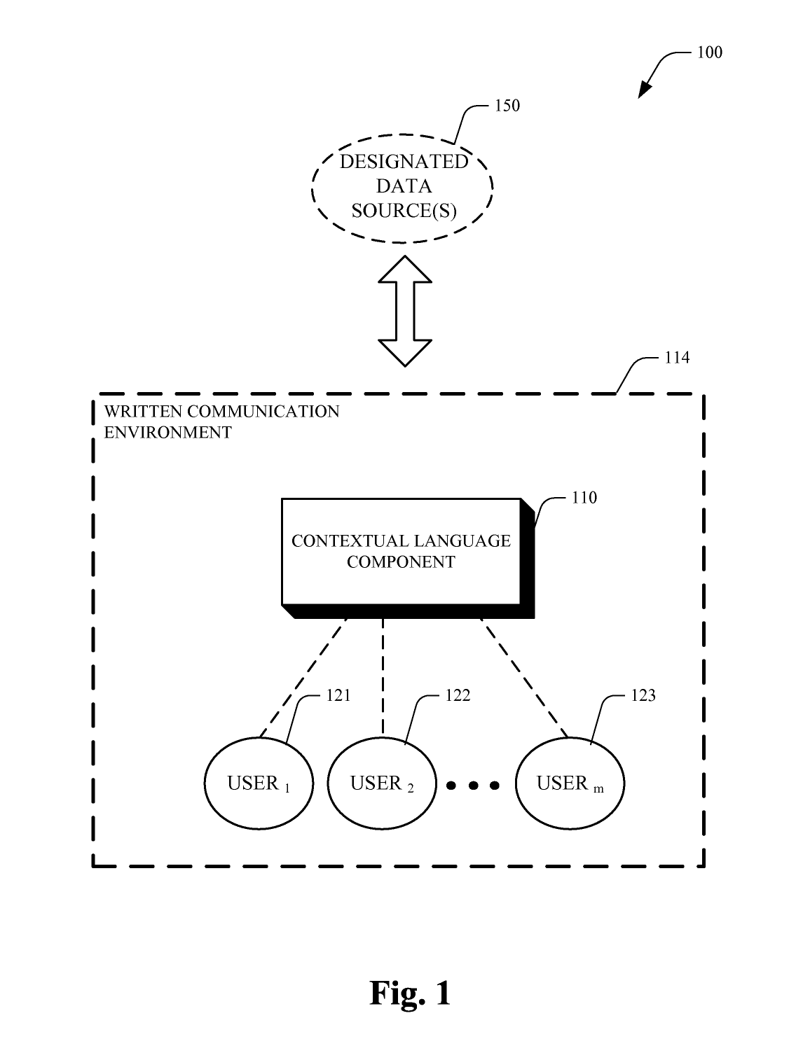

FIG. 1 illustrates a system 100 that employs a contextual language component 110 as part of the written communication environment 120. The contextual language component 110 can point any of the users 121, 122, 123 (1 thru m, where m is an integer) to a designated data source(s) 150 that is identified by the user via the contextual language component. Moreover, such contextual language component 110 can pull data from the designated source 150 for presentation to users in the written communication environment. In general, the written communication environment 114 employs an application or a space wherein general communication between users is primarily performed through typing keystrokes such as e-mails, web logs, instant messenger, and the like.

For example, during an e-mail communication, User₁ 123 can employ an operator, as will be described in detail infra, which is then interpreted by the contextual language component 110 to supply User₂ 122 with the designated data source 150, and such users can then continue communication. Hence, interactions between users are enriched, wherein the designated data source 150 can also be included as part of the interaction of users 121, 122, 123 in the written communication environment 1 14. The users 121, 122, 123 can also be part of a network (e.g., wireless network) such as a system area network or other type of network, and can include several hosts, (not shown), which can be personal computers, servers or other types of computers. Such host generally can be capable of running or executing one or more application-level (or user-level) programs, as well as initiating an I/O request (e.g., I/O reads or writes). In addition, the network can be, for example, an Ethernet LAN, a token ring LAN, or other LAN, or a Wide Area Network (WAN). Moreover, such network can also include hardwired and/or optical and/or wireless connection paths.

The connections can be shared among the users 121, 122, 123 who can employ, personal computers, workstations, and any device capable of text messaging such as mobile phones for example. Moreover, the networks can further include one or more input/output units (I/O units), wherein such I/O units can includes one or more I/O controllers connected thereto, and each of the I/O can be any of several types of I/O devices, such as storage devices (e.g., a hard disk drive, tape drive) or other I/O device. The hosts and I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters.

Moreover, the wireless communication network can be cellular or WLAN communication network; such as Global System for Mobile communication (GSM) networks, Universal Mobile Telecommunication System (UMTS) networks, and wireless Internet Protocol (IP) networks like Voice over Internet Protocol (VoIP) and IP Data networks. Accordingly, the portable device employed by users 121, 122, 123 can be a hand-held wireless communication device that can communicate with a wireless communication network, (e.g. wireless communication network) to engage in an enriched text messaging in the written communication environment 114.

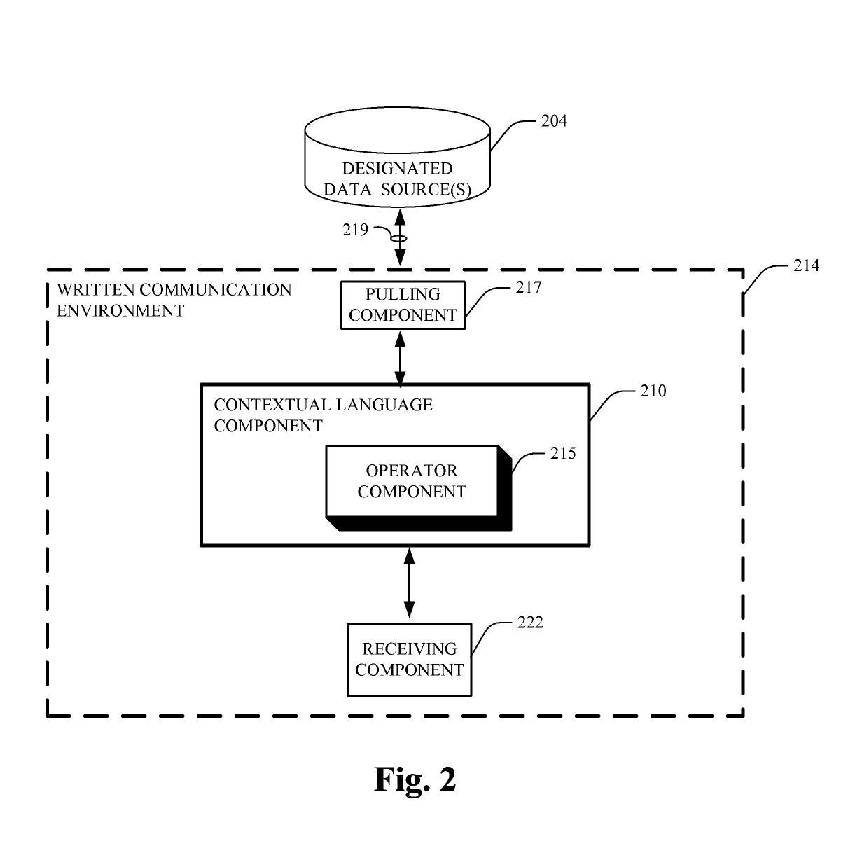

FIG. 2 illustrates a contextual language component 210 that includes an operator component 215 in accordance with an exemplary aspect of the subject innovation. The operator component 215 can define a syntax/grammar and name of the operator(s) with associated programming terms, and can be separated by commas, for example. Accordingly, the operator component 215 enables intuitive keywords and common abbreviations as part of the programming terms for performance of predefined functions on the designated data source. For example, the operator component 215 can be defined in a form that it is readily understood by a user by employing intuitive constructs such as employing a dollar sign to indicate finances, for example. It is to be appreciated that the data source can be in form of digitally encoded coherent signals, which the users can interact therewith (e.g., in real-time), such as users viewing video streams.

Moreover, such operator component 215 can describe where to obtain the data of interest, to further enrich communication between users, and what actions are to be performed thereupon. Hence, users who communicate in the written environment can type the operator, to engage in a predetermined functionality (e.g., playing a video). For example, a user can type an operator “video service; name of video”, which can then be interpreted by the application employed for written communication between the users—wherein the first slide of the video is then presented to the users within the written communication environment 214 (e.g., in an auxiliary window), and the users can continue communication.

Furthermore, the written communication environment 214 can include a receiving component 222 that receives text/messages from users to be processed by the contextual language component 210, which identifies and pull data from the designated data source 204. For example, a retrieval agent such as a pulling component 217 can pull data from the designated data source(s) 204 and publish such data to enable a rich interaction between the users within the written communication environment 214. The pulling component 217 can further generate an instance for a connection with the designated data source 204. Accordingly, the connection instance 219 can be employed to store connection information such as the state of data conveyance, the data being conveyed and a connection ID. Such information can be employed to monitor the progress of data transfer to the written communication environment 214, for example.

In a related aspect, the pulling component 217 can provide the instance to user machines within the written communication environment 214, which can lock the connection and instance and begin pulling and/or receiving data from the designated data source 204. As users of pull or receive data from the designated data source 204, received data can be posted and the connection instance can be concurrently updated to reflect any successful and/or failed data retrievals. Thus, at any given moment the connection instance includes the present state of data conveyance. Such information within the connection instance 219 can be employed to dynamically float the connection between machines within the written communication environment and, ensure reliable data conveyance, recover from message conveyance errors, support service windows, and the like.

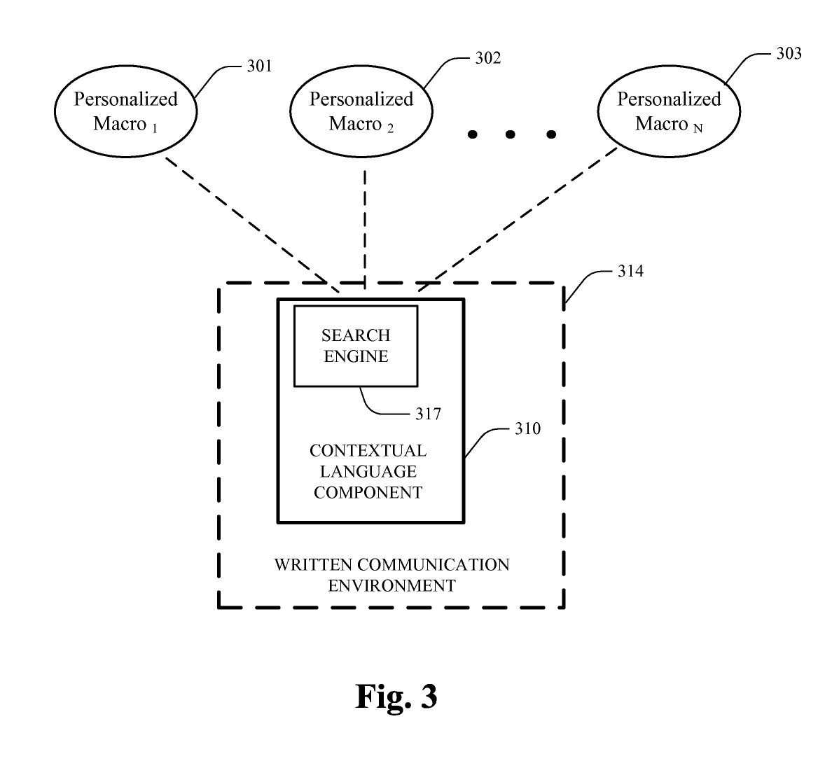

FIG. 3 illustrates a further aspect of a contextual language component 310 in accordance with a particular aspect of the subject innovation. The contextual language component 310 can further include a search engine 317 that locates the designated data source. The search engine 317 can filter the received results, based on a document property(s), a context parameter(s), and/or a configuration associated with the contextual language component and operators employed by the users. For example, document properties such as a term that appears on a web page, a property of the a URL (Uniform Resource Locator) identifying the web page, a property of URLs and web pages that link to the web page and layout, can be employed to determine what properties of a document, or web page are indicative of the document being relevant to the user who is identifying the designated data source through the operator. Moreover, the search engine 317 can be configured for the contextual language component 310 and its operators to differentiate between a result that is relevant and a result that is non-relevant to the operator context for a group of users. The configuration for the operators can be based on statistics and can comprise one or more context parameters (e.g., word probabilities and probability distributions).

In addition, the search engine 317 can employ filters via generating one or more context parameters for the designated data source. If a search result is determined to be relevant to the user, then designated data source can be provided to the user(s). If a search result is determined not to be relevant, then the located data source can be withheld from presentation to the user or provided after higher ranked results. For example, the search engine 317 can rank the results, based on document property(s), context parameter(s), and/or configuration. For example, the search engine 317 can be employed to determine the degree of relevance of the results, and subsequently rank the results from most relevant to non-relevant, based on a similarity measure and/or a confidence interval. For example, a technique can be employed to the filtered results in order to display the results to the user in an ascending or descending order, based on the relevance.

In a related aspect, the search engine 317 can employ personalized macros 301, 302, 303 (1 thru N, N being an integer) (e.g., defined by terms that are intuitive) created by a user, wherein such macros can be availed to another user in the written communication environment. For example, a user can write the macros in an Instant Messaging session (IM), and grant permission to another user to employ these macros. In a web log (blog) environment, the permission can be granted to other users to access data, wherein the search macro can appear and enable the other users to employ the macro and share operators created by the user. The search engine 317 can consider other criteria such as location, temporal criteria, language, comments, track-backs, and the like, for example.

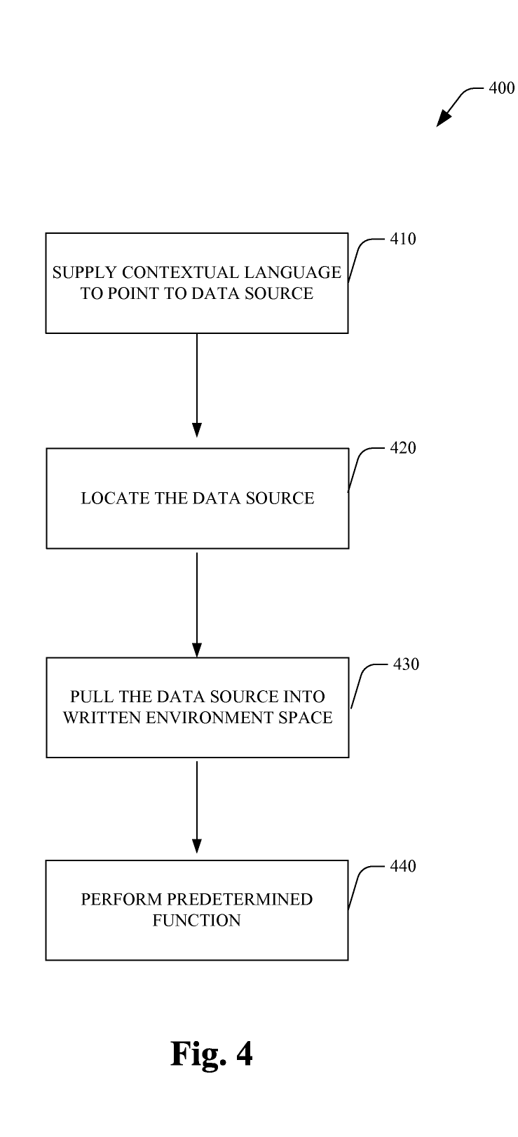

FIG. 4 illustrates a related methodology 400 of enriching user experience during text messaging in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and at 410 a contextual language can be supplied that points users to a designated data source within the written communication environment. Such data source can be an object, digital audio/video contents, text documents and in general any data content that is capable of being stored. The contextual language can define a grammar and name of the operator(s) with associated terms that can be separated by commas. Such operators can employ intuitive keywords and common abbreviations for performance of predefined functions. The contextual language component can further interact with a search engine that locates the designated data source at 420. Subsequently and at 430 the data source can be pulled into the written environment space and presented to the users during the written communication (e.g., e-mail, instant messaging and the like). At 440 the predetermined function (e.g., display of data) can be performed on the data.

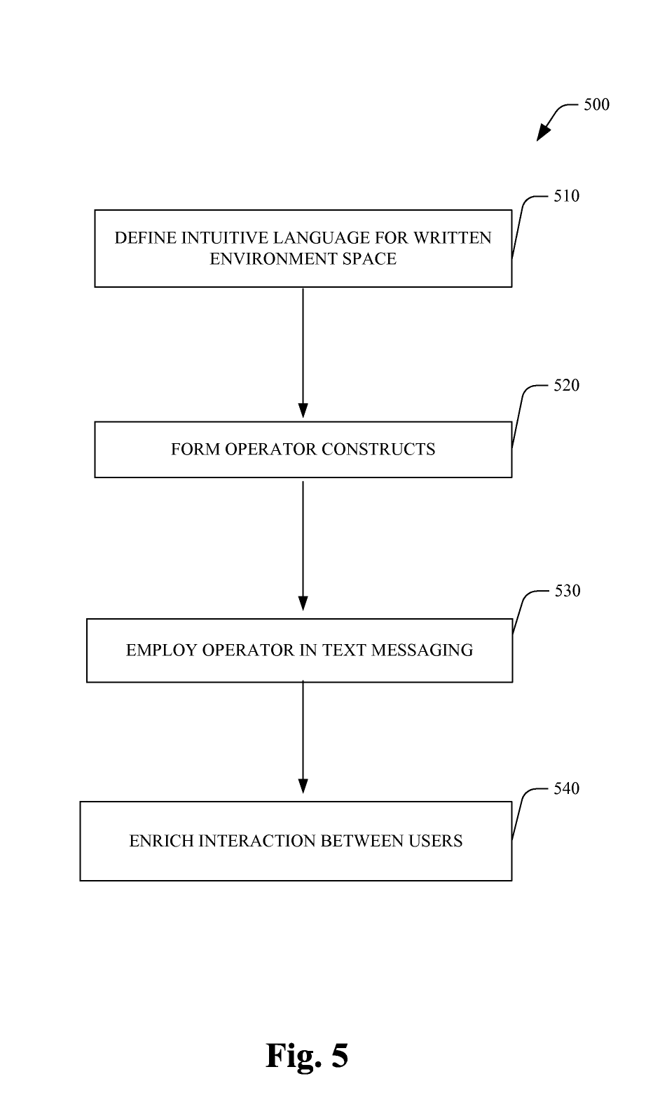

FIG. 5 illustrates a related methodology 500 of enhancing the communication between users in accordance with a further aspect of the subject innovation. Initially and at 510 an intuitive language can be defined in the written environment space. In general, such intuitive language is simple to express and understand that typically employs terms that have their obvious meanings. It is to be appreciated that one or more constructs can follow the operator, such as operator: term(s), wherein more than one term can be separated by commas.

At 520 such operator constructs are typically formed as intuitive key words, often from commonly used words, abbreviations or slangs. For example, “price:msft” is interpreted to obtain whatever the current stock price of “msft”, wherein “msft” is an abbreviation that people often associate it with one publicly traded stock of Microsoft™ corporation. Likewise, operator construct “Search: topic”, can convert the topic into a search link, or even display the top five results in the written environment space (e.g., Instant Messaging) itself. At 530, users can employ the defined operator in text messaging to enrich such communication. For example, the operator “VideoService: link” can supply the first image of the video from the designated video service and display to both sender and receiver (e.g., display a play button.) Hence, upon pressing the play button such video can be played on IMs of both the receiver and sender, wherein users can continue text messaging, while observing the video during the session. Moreover, if the sender has a nickname for its favorite videos then “VideoService:nickname” can also have the same functionality. The nickname can resolve to an actual link by a gadget program on the client machine or can be resolved by a web service. Accordingly, and at 540 communications between users can be enriched, wherein text messaging can leverage from the predefined functions performed by the operators.

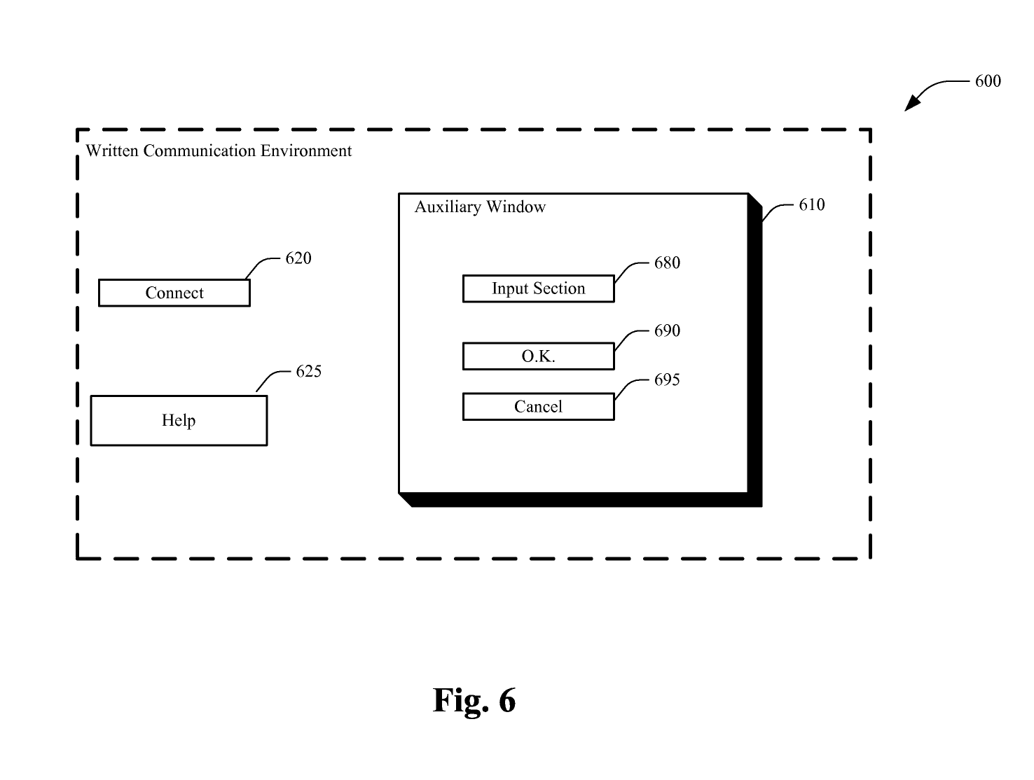

FIG. 6 illustrates an auxiliary window 610 that can be employed within the written communication environment 600, during the text communication. When the user selects the button connect 620 from an application menu within the written communication environment, the auxiliary window 610 opens in form of a view dialog, to display the designated data source. For example, the auxiliary window 610 can be employed for watching or displaying content pulled into the written communication environment 600. Moreover, an input section 680 enables a user to enter a username, password, and/or domain name for accessing the designated data source. When desired selections described within an operator have been made by the user, an OK input 690 can notify the server, which is associated with the designated data source, for a connection. A cancel button 695 can also be provided to close the auxiliary window 610 and dismiss current actions. Likewise, a help button 625 can further be supplied, wherein if selected, provides predetermined information to help the user employ the auxiliary window 610. Users can continue to chat/text message while predefined functions are performed on the designated data sources, which can be displayed in the auxiliary window 610. It is to be appreciated that IM providers can also provide a mouse clickable UI, where the user can click or drag and drop the operators to choose therefrom.

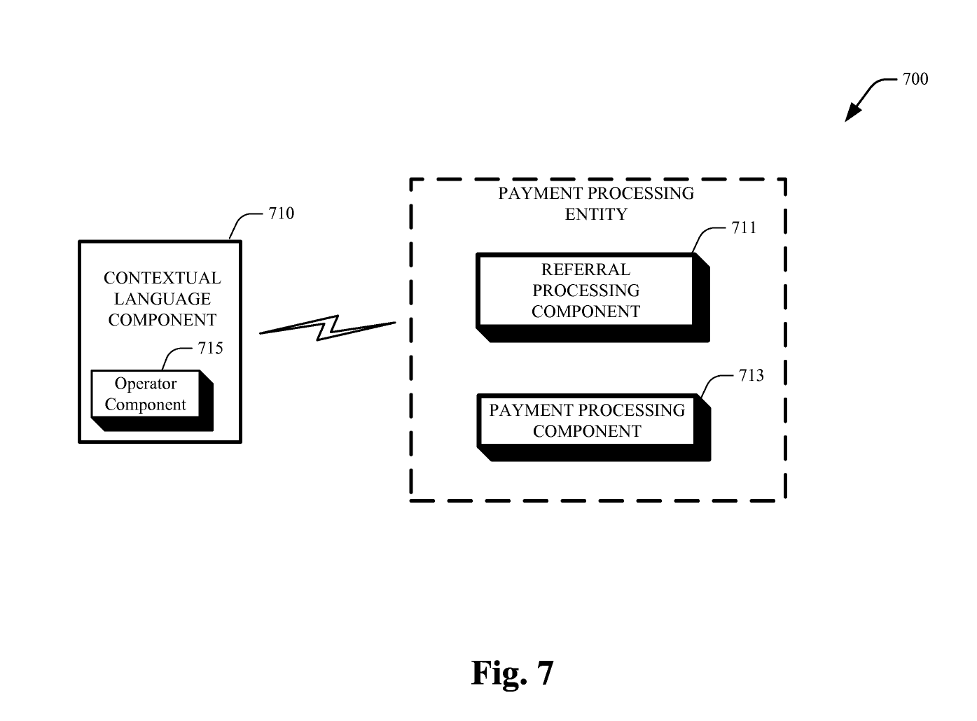

FIG. 7 illustrates the contextual language component 710 with an operator component 715 that defines predetermined functions (e.g., transfer of money) related to payment processing. Such operator component 715 can employ intuitive terms that signify payment such as “pay amount”, wherein the designated sum can be transferred from the sender account to the recipient account, followed by a confirmation. The operator component 715 can also automatically initiate account verification process such as obtaining a secured password for the transfer process. For example, the operator component 715 can be employed when users have to settle debts via a payment processing component 713, and can further be implemented in banking applications.

The system 700 can be implemented in connection with a commercial transaction and can include proprietary network transaction data flows on payment gateways, which take payment requests from users and route such request to proper processing entities, for example. In general, payment processing component 713 can settle charges with payment providers (e.g., Visa® and MasterCard®), as part of the front end between users. The payment operator can also automatically initiate account verification process such as obtaining a secured password for the transfer process. For example, the payment operator can be employed when users have to settle debts, and can further be implemented in shopping applications.

In addition, the operator component 715 can function as a “refer” operator, wherein the operator component 715 enables the sender to send marketing material (e.g., promotion, coupon, recommendation, advertisement and the like to) the recipient through the coupon processing component 711. Such refer operator can typically supply associated accounting, (e.g., the name of the sender can be embedded in the promotion/coupon/recommendation/advertisement, which helps send the referral fee to the right account, even if the recipient buys the product later after closing the IM connection and thru the referral processing component 711. For example, the referral operator can be employed when the sender sends a song to the recipient, and if the recipient enjoys such song, then the recipient can purchase the song—wherein a referral fee can then be submitted to the sender. As such, the operator component 715 of the subject innovation can leverage the existing security protocols and payment processing infrastructure, to facilitate payment processing between users. Moreover, existing trust relations that have been established can be employed (e.g., established relationships between users in a buddy list, and the like.) It is to be appreciated that other operators can be defined as part of the written communication environment, which can further pull data from the sender local devices (e.g., desktop, gadgets, and the like), for sending to the recipient. Moreover, third parties can provide operator packages for a category of users, (e.g., doctors, financial analysts, students, and the like) who employ their own set of needs, slangs, and linguistics). Such operator package specially made for these users can further facilitate communication therebetween.

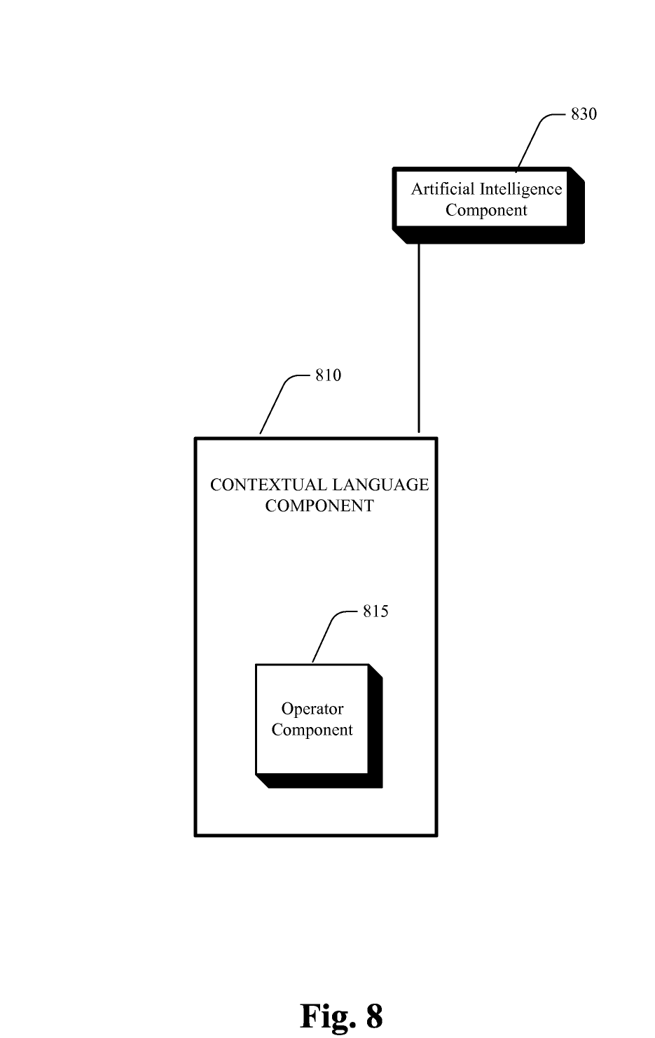

FIG. 8 illustrates an artificial intelligence (AI) component 830 that can be employed to facilitate inferring and/or determining when, where, how to access the designated source as identified by the operator component 815 in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 830 can employ any of a variety of suitable AI-based schemes as described supra in connection with facilitating various aspects of the herein described invention. For example, a process for learning explicitly or implicitly how or when a designated data source should be accessed can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

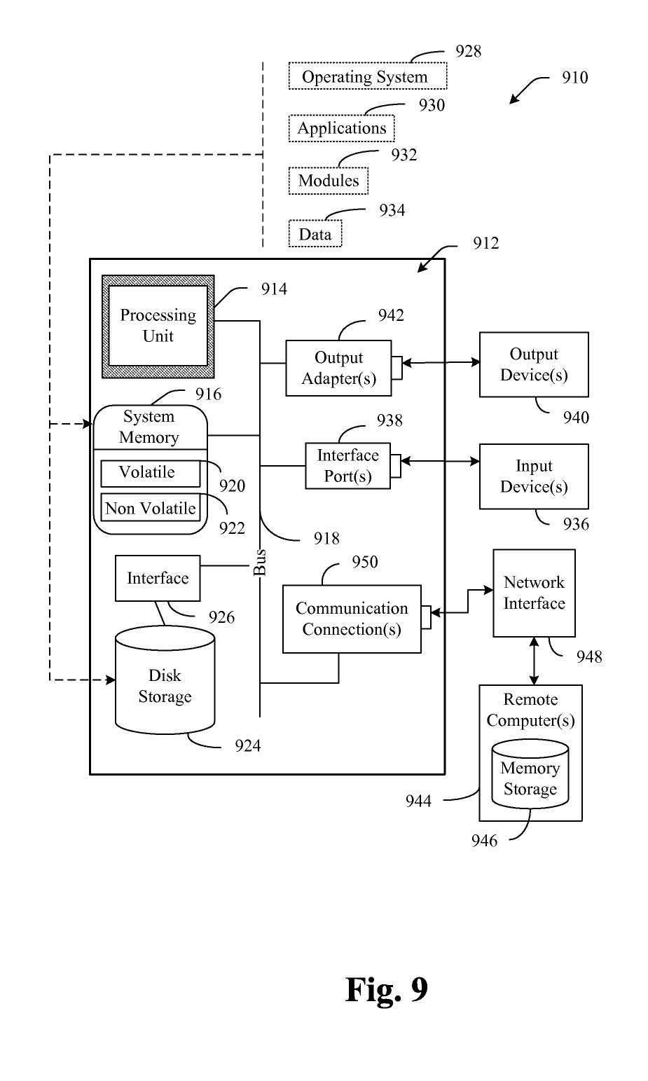

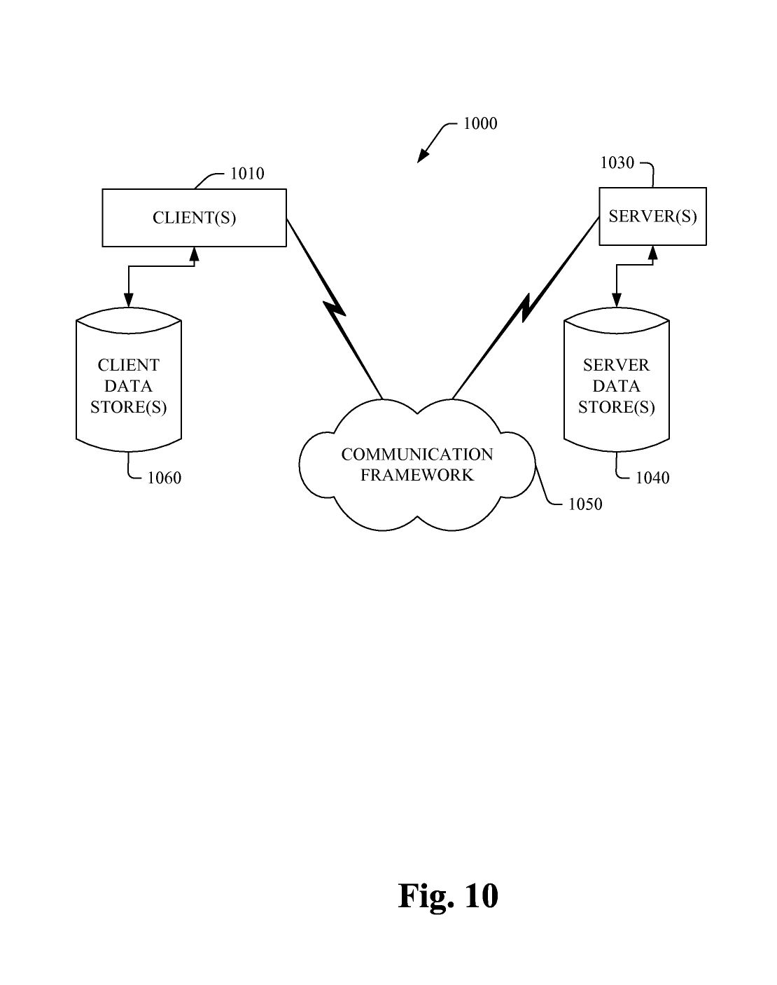

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed in a written communication environment of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a contextual language component that points to a designated data source during written communication between users; and
a pulling component that pulls data from the designated data source into an environment of the written communication.

2. The computer implemented system of claim 1 further comprising an operator definable by a user to perform a predetermined function on the designated data source.

3. The computer implemented system of claim 1, the environment of the written communication further comprising an instant messenger or an e-mail or a web log or a combination thereof.

4. The computer implemented system of claim 2, the predetermined function related to playing digital media.

5. The computer implemented system of claim 2, the predetermined function related to settlement of debts between users.

6. The computer implemented system of claim 1 further comprising a search engine that locates the designated data source.

7. The computer implemented system of claim 6 further comprising macros created by the users.

8. The computer implemented system of claim 5 further comprising a payment processor and a referral processing component.

9. The computer implemented system of claim 1 further comprising an auxiliary window that displays the designated data source in the environment.

10. The computer implemented system of claim 1 further comprising an artificial intelligence component that facilitates access to the designated data source.

11. A computer implemented method comprising the following computer executable acts:
supplying a contextual language that is defined by a user in a written communication environment, to point to a designated data source; and
pulling data from the designated data source into the written communication environment.

12. The computer implemented method of claim 11 further comprising defining grammar and name of operators to perform a predetermined function on the designated data source.

13. The computer implemented method of claim 11 further comprising displaying data from the designated data source in an auxiliary window of the written communication environment.

14. The computer implemented method of claim 11 further comprising employing the operator in text messaging.

15. The computer implemented method of claim 12 further comprising forming constructs as intuitive keywords.

16. The computer implemented method of claim 12 further comprising defining personalized search macros by the user, and searching for the designated data source by employing the search macros.

17. The computer implemented method of claim 16 further comprising viewing the data source as a video stream.

18. The computer implemented method of claim 12 further comprising inferring a manner of accessing the designated source.

19. The computer implemented method of claim 12 further comprising providing the operators by third parties.

20. A computer implemented system comprising the following computer executable components:
means for defining an operator with constructs intuitive to a user, the operator points to a designated data source during written communication between users; and
means for pulling data from the designated data source into an environment of the written communication.
